(19) United States
(12) Patent Application Publication
(10) Pub. No.: US 2026/0320565 A1
(43) Pub. Date: Oct. 15, 2026

(54) COORDINATING VEHICLE REPAIR

(71) Applicant: Swerve Industries LLC, Littleton, CO (US)

(72) Inventor: Cade Cushman, Littleton, CO (US)

(73) Assignee: Swerve Industries LLC, Littleton, CO (US)

(21) Appl. No.: 19/646,713

(22) Filed: Apr. 14, 2026

Related U.S. Application Data
(60) Provisional application No. 63/788,325, filed on Apr. 14, 2025.

(51) Int. Cl. G06Q 10/20

(52) U.S. Cl. CPC G06Q 10/20

(57) ABSTRACT

This disclosure covers systems, methods, and media that coordinate the repair of a vehicle among various users. An owner repair request may be received from an owner client device containing information related to a vehicle needing repair, the owner, and coordination. The owner repair request may be processed and a shop repair request and driver repair request may be generated and provided to a shop client device and one or more driver client devices. An option to claim the driver repair request may also be provided to the one or more driver client devices. Once a driver client device claims a driver repair request, the option to claim may be removed. A repair ticket may then be generated and provided to the owner. The owner repair request may be provided to one or more shop client devices with an option to bid on the owner repair request.

### DESCRIPTION

### RELATED APPLICATIONS

This application claims priority to U.S. Provisional Application Ser. No. 63/788,325, filed on Apr. 14, 2025.

### BACKGROUND

According to recent data, there are over two hundred, and eighty-three million vehicles registered within the United States. It is essential for these vehicles to have routine maintenance services to operate properly and to remain in good and workable condition. These routine maintenance services may include oil changes, tire rotations, replacing brakes, replacing batteries, transmission fluid flush, coolant flush, charging air conditioners, etc. In addition to these routine maintenance services, vehicles will from time to time need more extensive maintenance services such as replacing spark plugs and ignition coils, repairing gaskets, repairing the suspension, etc.

While there are approximately one hundred and eighty thousand auto repair shops in the United States, it is estimated that approximately sixty-four percent of drivers in the United States are putting off necessary car maintenance. For example, recent data suggests that twenty-nine percent of car owners are behind on oil changes, forty-four percent of car owners have not rotated their tires at required times, and one in five car owners are behind on both oil changes and tire rotations.

### SUMMARY

This disclosure describes one or more embodiments of methods, systems, and non-transitory computer readable storage medium that coordinate the repair of a vehicle, which may include routine maintenance services, more extensive maintenance services, minor to complex repair services, and any other repair services a vehicle may need, among a vehicle owner, a driver, and a repair shop. As part of the coordination of the repair of a vehicle, the disclosed methods, systems, and medium may receive or cause to be received an owner repair request from an owner client device that is associated with a vehicle owner user. The owner repair request may be comprised of a plurality of content items containing information about a vehicle, one or more services requested, and repair coordination. The content items containing information about a vehicle may include the vehicles make, model, year, mileage, VIN number, license plate number, or other information related to the vehicle. The content items containing information about the one or more services requested may include any services requested by the owner to be completed on the vehicle such as, but not limited to, oil change, brake fluid flush, front and/or rear rotor replacement, front and/or rear brake replacement, battery replacement, wheel remount and rebalance, tire rotation, engine air filter replacement, cabin air filter replacement, front and/or rear wiper blade replacement, or any other repair or service requested to be completed. The information about the coordination may include the date service should be performed, the address the vehicle should be retrieved from, the time the vehicle will be available for pickup, the time the vehicle will need to be returned, any specific instructions about the vehicle or pickup, or any other information related to coordination of the repair.

The methods, systems, and medium may generate or cause to be generated a shop repair request. The shop repair request may contain one or more of the content items of the owner repair request and may further include one or more shop related content items derived from the plurality of content items of the owner repair requests. For example, the one or more shop related content items may include an estimated time the vehicle will arrive at a repair shop, an estimated time the repair needs to be completed by, or other items of information pertinent to the repair shop to complete the repair.

After generating or causing the shop repair request to be generated, the methods, systems, and medium may provide or cause to be provided the shop repair request for display on a shop client device associated with an auto repair user. The auto repair user being associated with an auto repair shop.

The methods, systems, and medium may generate or cause to be generated a driver repair request. The driver repair request may contain one or more of the content items of the owner repair request and may further include one or more driver related content items derived from the plurality of content items of the owner repair request. For example, the one or more driver related content items may include a time to pick up the vehicle, a time to return the vehicle, an estimated wait time for repair completion, or other items of information pertinent for a driver picking up the vehicle for repair.

After generating or causing the driver repair request to be generated, the methods, systems, and medium may provide or cause to be provided the driver repair request for display on one or more driver client devices associated with one or more driver users together with an option to claim the driver repair request.

Upon providing the option to claim the driver repair request, the methods, systems, and medium may receive or cause to be received from a claiming client device associated with a driver, a claim from the option to claim the repair request. Additionally, the methods, systems, and medium may remove, or cause to be removed the option to claim the repair request from display on one or more of the remaining driver client devices.

The methods, systems, and medium may provide or cause to be provided an option to cancel the claim for display on the on the claiming client device and to receive or cause to be received from the claiming client device a cancellation of the claim from the option to cancel. Upon receiving the cancellation from the claiming client device, the methods, systems, and medium may again provide the option to claim the driver repair request for display on one or more driver client devices together with the option to claim the driver repair request.

The methods, systems, and medium may generate or cause to be generated a repair ticket comprised of content items derived from the shop repair request and the driver repair request and provide the repair ticket for display on the owner client device.

The methods, systems, and medium may further receive or cause to be received status updates from the shop client device and status updates from the claiming client device related to the vehicle being repaired. The status updates may include receipt of the vehicle by the driver, receipt of the vehicle by the shop, completion of the repair by the shop, the driver picking up the vehicle from the shop, the driver returning the vehicle to the owner, etc.

From the status updates, the methods, systems, and medium may generate or cause to be generated one or more status notifications, related to the vehicle being repaired, derived from the status updates received from the shop client device and the claiming client device. The methods, systems, and medium may then provide or cause to be provided for display on the owner client device, one or more status notifications.

After return of the vehicle to the owner, the methods, systems, and medium may provide or cause to be provided for display on the owner client device a review interface with an option to review the repair shop and the driver.

### BRIEF DESCRIPTION OF THE DRAWINGS

A more particular description of the disclosure along with related advantages and features will be rendered by reference to specific embodiments thereof that are illustrated in the appending drawings. These drawings only depict typical embodiments of the present disclosure and are not to be considered to be limiting of its scope. Various embodiments of the disclosure will be described and explained with additional specificity and detail through the use of the accompanying drawings, in which:

FIG. 1 illustrates a schematic diagram of a system for coordinating vehicle repair in accordance with one or more embodiments described herein;

FIG. 2 illustrates a block diagram of an environment for implementing the system of FIG. 1 in accordance with one or more embodiments described herein;

FIG. 3 illustrates a method-flow diagram showing the system of FIG. 1 interacting with a first client device, a second client device, and a third client device to coordinate vehicle repair in accordance with one or more embodiments described herein;

FIG. 4 illustrates a flow diagram of a method of coordinating vehicle repair in accordance with one or more embodiments described herein;

FIG. 5 illustrates another flow diagram of a method of coordinating vehicle repair in accordance with one or more embodiments described herein; and

FIG. 6 illustrates a block diagram of a computing device in accordance with one or more embodiments.

### DETAILED DESCRIPTION OF THE PREFERRED EMBODIMENTS

As shown in the drawings and for purposes of illustration, the one or more embodiments disclosed herein facilitate the effective coordination of vehicle repairs among drivers, vehicle owners, and auto shops and thereby improve the efficiency and ease in accomplishing a repair on a vehicle. As used herein the term driver may refer to a user picking up a vehicle from its owner, driving the vehicle to an auto repair, and returning then the vehicle to its owner. As used herein, a vehicle owner may refer to a user of the system that owns a vehicle in need of a repair. As used herein, an auto shop may refer to a user of the system who performs repairs on vehicles as a service. As used herein the term repair may refer to any repair or maintenance service that a vehicle may need from a simple oil change, tire rotation, etc. to a complex repair such as a transmission overhaul, head gasket replacement, etc.

In general, one or more embodiments of the system improve one or more users’ experience in coordinating and accomplishing a vehicle repair by using a system that is non-native to one or more client devices associated with one or more users. For example, the system may receive a plurality of repair requests from one or more client devices associated with vehicle owners, may receive a plurality of bids from one or more client devices associated with auto shops, and may generate a plurality of repair coordinations for the plurality of repair requests received. The system may further provide to a client device associated with a vehicle owner access to a repair coordination associated with that client device and may further allow the client device with access to the repair coordination and may further allow the client device to view, open, accept, modify, or otherwise interact with the repair coordination. The system may further apply the client device’s edits to the repair coordination. The system may also edit and modify the repair coordination without input from the client device according to the methods and processes described in more detail below.

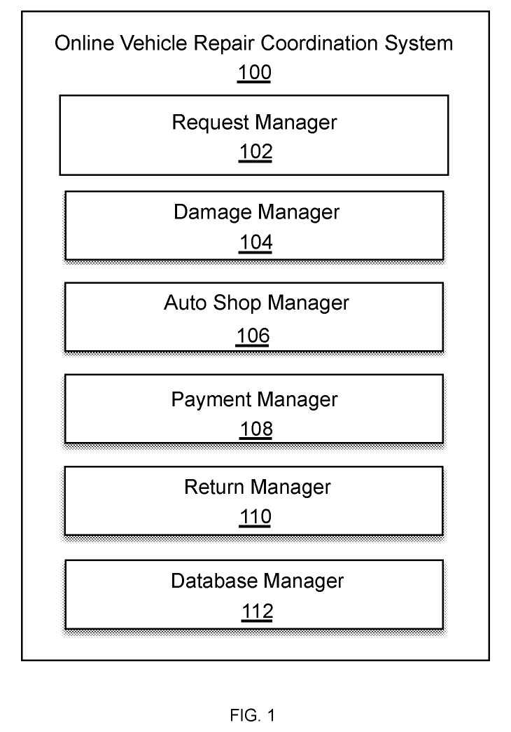

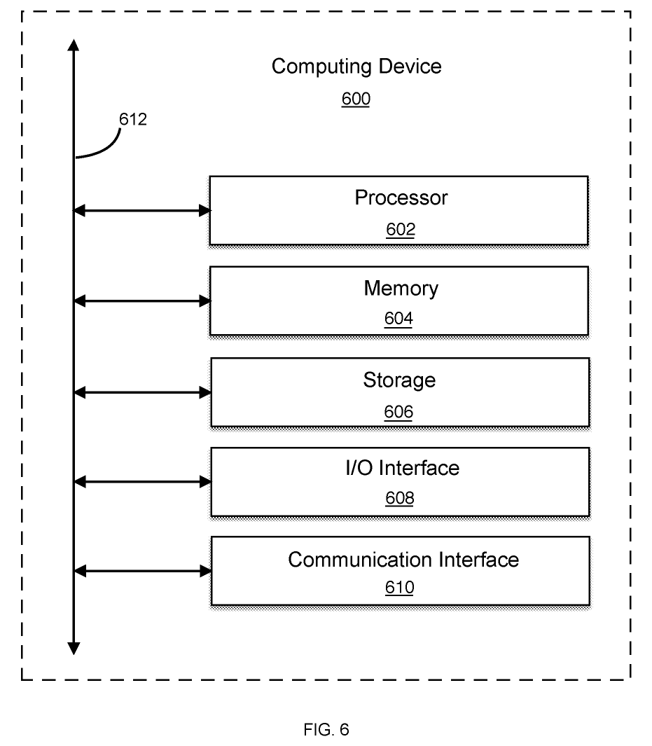

With reference now to FIG. 1, an example embodiment of a vehicle repair coordination system 100 (the “system”) in accordance with one or more principles described herein is illustrated. As shown, the system 100 may include request manager 102, damage manager 104, autoshop manager 106, payment manager 108, return manager 110, and database manager 112. Each of the components of system 100 may be in communication with one another using any suitable communication technologies. It will be recognized that although components 102-112 are shown to be separate in FIG. 1, any of components 102-112 may be combined into fewer components, such as into a single component, or divided into more components as may serve a particular embodiment. In addition, components 102-112 may be implemented by or located on one or more computing devices, such computing devices being described below in connection with FIG. 6. In the alternative, portions of system 100 may be implemented on a client device or multiple client devices with other portions of system 100 being implemented on the online vehicle repair coordination system 100 as described below.

The components 102-112 may comprise software, hardware or a combination thereof. For example, components 102-112 may comprise one or more instructions stored on a computer-readable storage medium and executable by one or more processors of one or more computing devices. When executed by the one or more processors, the computer executable instructions of system 100 may cause a computing device to perform the methods described herein. Alternatively, components 102-112 may comprise hardware, such as a special purpose processing device to perform a certain function or group of functions. Additionally or alternatively, components 102-112 may comprise a combination of computer-executable instructions and hardware.

As already described above, system 100 may include a request manager 102. Request manager 102 may present, receive, provide, manage, and/or control access to one or more owner repair requests for display on an owner client device associated with a vehicle owner. More specifically, request manager 102 may present an owner repair request to the owner client device and give the owner client device the option to interact with, modify, or create a plurality of content items associated with the owner repair request. The plurality of content items may include information about the type or types of repairs requested for a vehicle such as an oil change, tire rotation, diagnosis of a check engine light, or any other repair that the vehicle may be in need of. The plurality of content items may also include information about the vehicle such as the make, model, year, VIN number, mileage, license plate number, or other information concerning the vehicle. Additionally, the plurality of content items may include information about repair coordination such as the owner’s name, the owner’s contact information such as phone or email, the pick-up address, the pick-up time, the time the vehicle is needed back, the address the vehicle should be returned to, or other information concerning coordination of the repair. The owner client device may engage with the repair request to modify, create, or otherwise interact with the plurality of content items and to submit the repair request back to the request manager 102. The request manager 102 may receive the repair request from client device with the client device’s input.

The request manager 102 may provide the owner repair request to one or more client devices associated with auto shops. The request manager 102 may control access to certain input received in connection with the repair request and only provide certain input to auto shop client devices. Alternatively, the request manager 102 may generate a shop repair request and provide the shop repair request for display on a shop client device associated with an auto repair user. The request manager 102 may give the shop client device the ability to view, modify, create or otherwise interact with a plurality of content items associated with the shop repair request. The shop repair request may include one or more of the content items from the owner repair request and one or more shop related content items derived from the plurality of content items of the owner repair request. For example, the shop repair request may include one or more content items from the owner repair request such as the VIN number of the vehicle, the type or types of repairs requested, or other content items from the owner repair request. Additionally, the shop repair request may include one or more content items derived from the one or more content items of the owner repair request, and a driver repair request as described further below, such as an approximate time the vehicle will arrive at the shop, a time the repair on the vehicle needs to be completed by or other information concerning the shop.

Alternatively, the request manager 102 may provide a biddable shop repair request to one or more shop client devices to view and input bids on the biddable shop repair request. The request manager 102 may allow the one or more shop client devices to modify, create, or otherwise interact with the content items of the biddable shop repair request. The content items of the biddable shop repair request may include the same content items as the shop repair request described above but may further include bidding contents items. The request manager may allow the one or more shop client devices to input bids or to otherwise provide estimates or other information concerning the estimated cost of the repair and the estimated time for completion. The request manager 102 may receive the bids and arrange the bids from best to worst based on a number of weighing factors such as cost, time of repair, distance of the auto shop from the current location of the vehicle, reviews of the auto shop, etc.

The request manager 102 may provide the received bids to the owner client device as arranged by the request manager 102 from best to worst, the request manager 102 may provide suggestions as to which bids to choose to the owner client device. The request manager 102 may further provide a filter to the owner client device such that the owner client device can view different bids based on cost, distance, auto shop reviews, time of repair or other relevant factors. The request manager 102 may allow or provide an option to the owner client device to select and confirm a bid. Once the request manager 102 receives a confirmed bid from the owner client device, the request manager 102 may generate and provide a notification notify the shop client device associated with the bid of the confirmation.

The request manager 102 may generate a driver repair request and provide the driver repair request for display on one or more driver client device associated with driver users. The request manager 102 may give the driver client device the ability to view, modify, create or otherwise interact with a plurality of content items associated with the driver repair request. The driver repair request may include one or more of the content items from the owner repair request and one or more driver related content items derived from the plurality of content items of the owner repair request. For example, the driver repair request may include one or more content items from the owner repair request such as the VIN number of the vehicle, the vehicle’s license plate number, the make, model, and year of the vehicle, the pick-up address, the return address, or other content items from the owner repair request. Additionally, the driver repair request may include one or more content items derived from the one or more content items of the owner repair request such as the approximate distance and time to the pick-up location for the vehicle, the approximate distance and time from the pick-up location to the auto shop, the time the vehicle should be returned to the return address, or other pertinent information for the driver.

The request manager 102 may further provide an option to the one or more driver client devices to claim the driver repair request. For example, after providing the driver repair request for view by the one or more driver client devices, one driver client device, referred to as the claiming client device, may take the option provided by the request manager 102 and claim the driver repair request indicating that the driver client device will accomplish and complete the driver repair request. In response to the claim selection by the claiming client device, the request manager 102 may remove from display on the one or more non claiming or remaining driver client devices the option to claim the driver repair request. The request manager 102 may provide the owner client device and/or the shop client device the real time location of the claiming client device.

Alternatively, the request manager 102 may receive availability information from one or more driver client devices such as days and times the drivers are available. The request manger 102 may match available drivers to an owner repair request or confirmed bid and arrange the matched drivers in a list of best to worst based on a number of weighting factors such as distance of the driver to the vehicle needing repaired, the reviews of the driver, etc. The request manager 102 may provide the list of matched drivers to the owner client device. The request manager 102 may allow the owner client device to view and select a desired matched driver and receive the owner client device’s selection. The request manager 102 may notify the selected driver client device of the selection. The request manager 102 may provide the owner client device with real time location of the selected driver client device.

The request manager 102 may finalize the repair request by combining the inputs received from the owner client device, selected auto shop client device, and the selected driver client device. The request manager 102 may then provide the finalized repair request or repair ticket to the owner client device and/or the shop client device, and driver client device.

In an alternative embodiment, the request manager 102 may not generate and provide a shop repair request as described above. Alternatively, the request manager 102 may generate and provide a driver repair request to one or more driver client devices associated with a driver user as described above. The request manager 102 may generate and provide to the selected or claiming client device a two-dimensional, machine-readable barcode, such as a QR code or other type of code known in the art. The code may contain a shop repair request that may be accessed by a shop client device through the scanning of the code. The request manager 102 may provide to the driver client device an option to indicate the vehicle has been handed off to the shop.

Additionally, the request manager 102 may provide the selected or claiming client device the option to select additional repairs recommended by the shop. Upon selection of additional repairs, the request manager 102 may generate an optional repair request and provide the optional repair request for display on the owner client device. The request manager 102 may place a time limit for acceptance of the optional repair request such that if the optional repair request is not accepted by the owner client device within a set amount of time, it will expire. The request manager 102 may receive from the owner client device an acceptance of the optional repair request and generate a new machine-readable code containing information about the acceptance of the optional repair request to the selected or claiming client device.

As described above, system 100 may include damage manager 104 which may receive input from the selected driver client device or claiming client device (both referred to for simplicity simply as the claiming client device in this paragraph) and provide the received input to the owner client device. The damage manager 104 may allow or promote the claiming client device to take photographs and/or video of the exterior and/or interior of the vehicle subject to the repair request prior to the user of the claiming client device taking the vehicle to the selected auto shop. The damage manager 104 may also allow or promote the claiming client device to take photographs and/or video of the exterior and/or interior of the vehicle before leaving the vehicle with the selected auto shop. The damage manager 104 may further allow or promote the claiming client device to take photographs and/or video of the exterior and/or interior of the vehicle upon receiving the vehicle from the selected auto shop. Finally, the damage manager 104 may allow or promote the claiming client device to take photographs and/or video of the exterior and/or interior of the vehicle upon returning the vehicle to the owner. The damage manager 104 may receive the photographs and/or videos from the claiming client device. The damage manager 104 may analyze and compare the photographs and/or videos to detect any damage that may have occurred to the vehicle while in the hands of the user of the claiming client device or the selected auto shop. The damage manager 104 may generate a report indicating whether or not damage has been detected, what damage has been detected, whether the damage occurred while the vehicle was in possession of the user of the claiming client device or selected auto shop. The damage manager 104 may provide the report to the client device associated with the vehicle owner.

As described above, system 100 may include auto shop manager 106. Auto shop manager 106 may generate and provide notifications, generate and manage invoices, receive input from the selected auto shop client device, and receive input from the owner client device. For example, the auto shop manager 106 may generate and provide a notification to the owner client device and/or the auto shop client device once the vehicle has arrived at the selected auto shop. The auto shop manager 106 may generate and provide notifications to the owner client device and/or to the driver client device giving updates on the progress of the vehicle repair including when the vehicle repair is complete.

The auto shop manager 106 may receive input in the form of additional recommended services and repairs from the auto shop client device. In the case of receiving a vehicle requesting a repair diagnostic, the auto shop manager 106 may receive input from the auto shop client device containing the diagnostic codes generated from the vehicles onboard diagnostics system with the recommended repair and the cost of the repair. The auto shop manager 106 may generate a change order to the repair request from the input received from the auto shop client device and provide the change order to the owner client device. The auto shop manager 106 may receive input from the owner client device accepting, modifying, or rejecting the change order. From the input received from the owner client device, the auto shop manager 106 may generate a finalized change order and send the finalized change order to the auto shop client device and/or the owner client device.

System 100 may further include payment manager 108. Payment manager 108 may request and receive payment associated with the repairs made by the selected auto shop. For example, the payment manger 108 may generate a final invoice from information provided in the initial repair request, selected bid, and from any change orders. The payment manager 108 may provide the final invoice to the owner user device and/or the auto shop client device. The payment manager 108 may provide to the owner user device options for payment of the final invoice, including ACH transfer, credit card payment, or any other known methods of payment. The payment manger 108 may receive payment information from the owner user device and process the payment information. The payment manager 108 may deposit received payment into a bank account selected by and associated with the auto shop client device. After payment is managed, processed, received and finalized by the payment manager 108, the payment manager 108 may generate a receipt and provide the receipt to the owner client device and/or the auto shop client device.

As mentioned above, system 100 may also include return manager 110. Return manager 110 may manage the process of returning the vehicle to the owner. For example, return manager 110 may provide the driver client device a notification that it is time to return the vehicle to the owner. The return manager may also provide notifications to the owner client device such as a notification that it is time for the vehicle to be returned to the owner, a notification that the driver is enroute in returning the owner’s vehicle, a notification indicating the estimated time for the vehicle to be returned, and/or a notification that the vehicle has been returned to the owner.

In addition, the return manager 110 may prompt the owner client device or give the owner client device an option to leave reviews for the driver and/or the auto shop. The return manager 110 may receive input from the owner client device concerning their experience and ratings on the driver and/or the auto shop.

System 100 may further include database manager 112 which may manage the storage of inputs received by the managers 102-110 described above and reports generated by the managers 102-110, including, but not limited to, photographs, videos, repair requests, bids, change orders, damage reports, invoices, receipts, reviews, etc. on one or more databases which are accessible to system 100. Additionally, database manager 112 may control access to these items which are stored on the one or more databases. For example, database manager 112 may store an item or a copy of an item which was received by the system 100 onto one or more databases and control which client devices can access the various items.

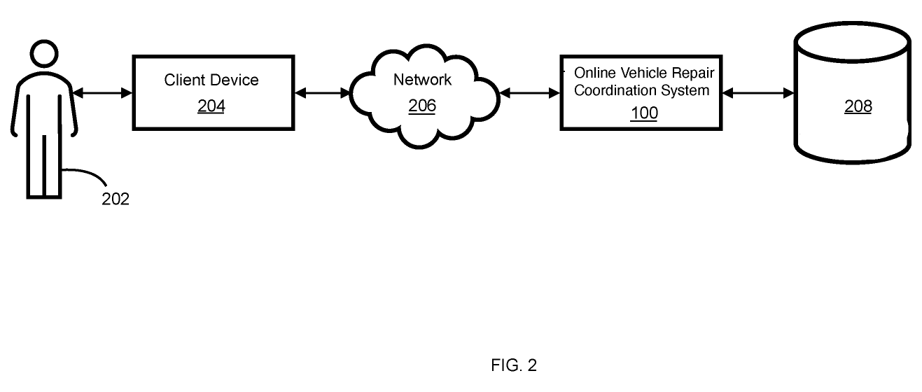

FIG. 2 illustrates an example environment 200 for implementation of the vehicle repair coordination system 100. As depicted in the figure, the example environment may include a user 202, a client device 204 which may be associated with the user 202, a network 206, the system 100 which may be in communication with the client device 204, and a database 208. At the outset, it is important to note that in some embodiments, the functions and features described herein may be performed entirely on system 100 alone. However, in the alternative, client device 204 may also perform one or more of the functions and features described with respect to system 100. Some or all of the functions and features described herein, in some embodiments, may be performed by both the system 100 and client device 204. It is also important to note that alternative embodiments may also include additional client devices associated with additional users as more fully described above and below.

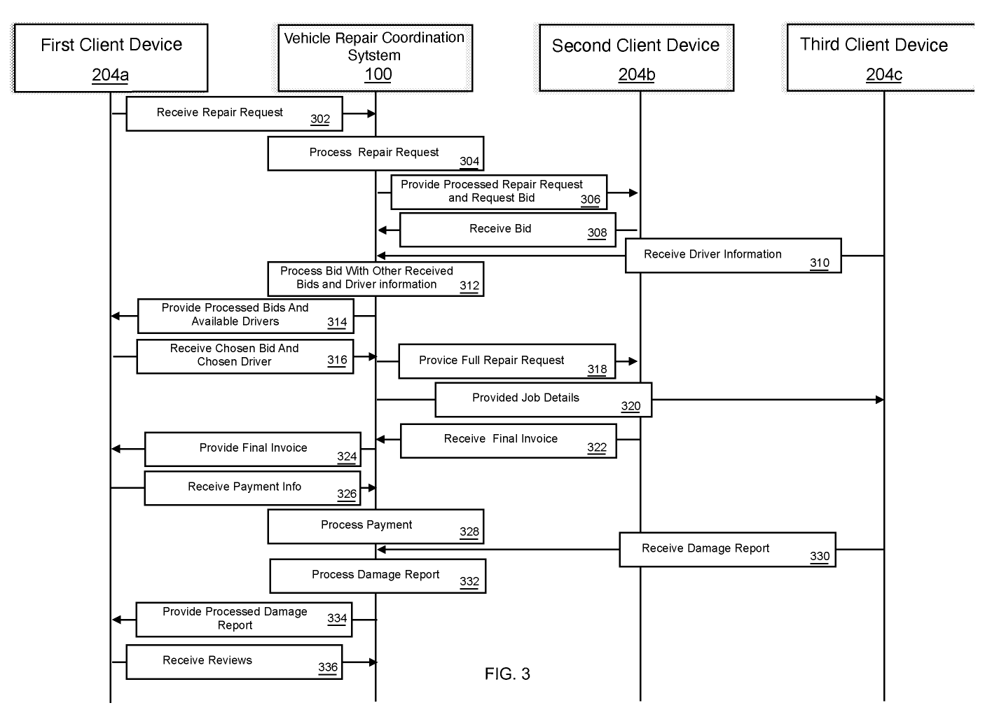

FIG. 3 illustrates a diagram showing an example method flow of the vehicle repair coordination system 100 interacting with first client device 204a, with second client device 204b, and with third client device 204c, to effectuate the repair of a vehicle. The vehicle repair coordination system 100, first client device 204a, second client device 204b, and third client device 204c may be example embodiments of corresponding components as described in connection with FIG. 2. As mentioned above, the system 100 is not limited to interacting with one or two client devices but may interact with a plurality of client devices 204. For example, system 100 may interact with a plurality of client devices associated with a vehicle owner, a plurality of client devices associated with auto repair shops, and a plurality of client device associated with drivers. For example, the coordination of repair of a vehicle may require collaboration from one or more of a vehicle owner, auto shops, and drivers in which case, system 100 may interact with a plurality of client devices associated with each user. For purposes of illustration and for the following description below, first client device 204a may be associated with a vehicle owner, second client device 204b may be associated with an auto repair shop, and third client device may be associated with a driver. Again, as mentioned above, client devices may preferably be tablet devices, but may also be desktop computers, laptops, smart phones, or any other device known in the art capable of interacting with system 100.

As shown in step 302, the system may receive an owner repair request from a first client device 204a associated with a vehicle owner. The owner repair request may include a plurality of content items containing information related to, but not limited to, the nature of repair requested, the vehicle needing repaired, and coordination information for the repair. Information received related to the nature of the owner repair request may include details on the repair needed such as, but not limited to, an oil change, a tire rotation, replacing a battery, diagnosing a check engine or other status light, etc. Information received related to the vehicle needing repair may include specific details about the vehicle such as, but not limited to, the make of the vehicle, the year of the vehicle, the model of the vehicle, the engine size of the vehicle, the vehicle’s VIN number, the license plate number, the mileage, etc. Information received relating to coordinating the repair may include the contact information of the owner such as, but not limited to, the vehicle owner’s name, the vehicle owner’s address, the vehicle owner’s phone number, the vehicle owner’s email address, the date the vehicle will be available for pick up, the time the vehicle will be available for pick up, the date and time the vehicle needs to be returned, etc.

In step 204, the system 100 may process the owner repair request. The processing may include modifying the repair request into an abbreviated repair request. For example, the system 100 may take certain information from the owner received repair request and create a new abbreviated repair request only including some of the total information received. The information on the abbreviated repair request may include some of the vehicle information, such as, but not limited to, the make of the vehicle, the year of the vehicle, the model of the vehicle, and the engine size of the vehicle. The abbreviated repair request may further include details on the repair needed such as, but not limited to, an oil change, a tire rotation, replacing a battery, diagnosing a check engine or other status light, etc.

Alternatively, the system 100 may generate a shop repair request including one or more of the content items from the owner repair request and one or more shop related content items derived from the content items of the owner repair request and the driver repair request as previously described above. Additionally, the system 100 may generate the driver repair request including one or more of the content items from the owner repair request and one or more driver related content items derived from the content items of the owner repair request and the content items from the shop repair request.

In step 306, the system 100 may provide the processed repair request to and request a bid from a second client device associated with an auto shop. While FIG. 3 only shows one second client device associated with an auto shop, the system 100 may provide the processed repair request to multiple second client devices associated with different auto shops. Additionally, the system 100 may request bids from multiple second client devices associated with different auto shops. Alternatively, the system 100 may provide the shop repair request to the second client device without requesting a bid.

In step 208, the system 100 may receive a bid from the second client device associated with an auto shop. As with step 206, while FIG. 3 only shows one second client device associated with an auto shop, the system 100 may receive multiple bids from multiple second client devices associated with different auto shops. The bids may contain information such as, but not limited to, the estimated cost of the repair, the estimated competition time for the repair, the contact information of the auto shop including physical address, telephone number, website, and email, etc.

In step 310, the system 100 may receive driver information from the third client device associated with a driver. As with step 208, while FIG. 3 only shows one third client device associated with a driver, the system 100 may receive information from multiple third client devices associated with different drivers. The driver information may include, but not be limited to, the availability of the driver, the current address or location of the driver, the driver’s reviews, etc.

In step 312, the system 100 may process the received bids and driver information. In processing the bids, the system 100 may organize the bids from the most favored bid first to the least favored bid last. To determining the order of the bids, the system 100 may consider a variety of factors such as the estimated cost of the repair, the distance from the vehicle to be repaired to the auto shop on the bid, the estimated time to complete the repair, reviews of the auto shop, etc.

The system 100 may also process the received driver information. In processing the driver information, the system 100 may organize the drivers represented by the driver information from the most favored driver first to the least favored driver last. To determining the order of the drivers, the system 100 may consider a variety of factors such as the distance of the driver to the vehicle to be repaired, how soon the driver would be available, reviews of the driver, etc.

In step 314, the system 100 may provide the processed bids and driver information to the first client device 204a associated with the vehicle owner. The vehicle owner may then review the processed bids and the driver information on the first client device 204a and select one bid and one driver to move forward with getting the owner’s vehicle repaired.

In step 316, the system 100 may receive the bid chosen by the first client device 204a. The system 100 may also receive the driver information chosen by the first client device 204a.

In step 318, the system 100 may provide the full repair request to the second client device 204b associated with the auto shop whose bid had been selected by the first client device 204a. The full repair request may contain all of the information listed above in association with the repair request received by the system in step 302.

In step 320, the system 100 may create and provide job details to the third client device 204c associated with the driver who had been selected by the first client device 204a. The job details may include the name of the vehicle owner, the address of the vehicle owner, the telephone number of the vehicle owner, the car information such as the make, model, and year of the car, the VIN number, the license plate number, the mileage, and any other information that the vehicle owner through the first client device 204a included on the repair request concerning how the vehicle to be repaired should be retrieved by the driver.

In step 322 through step 328, the system 100 may receive information from both the second client device 204b associated with the auto shop and the first client device 204a associated with the vehicle owner concerning payment for the repair done by the auto shop. For example, in step 322, the system 100 may receive a final invoice from the second client device 204b after the auto shop has completed repair of the vehicle. In step 324, the system 100 may provide the final invoice to the first client device 204a. The first client device 204a may review the invoice and upload payment information. In step 326, the system 100 may receive the payment information uploaded by the first client device 204a. Finally, in step 326, the system 100 may process the payment information received. The step 236 of processing the payment information may include receiving a payment and depositing the payment into a bank account associated with the second client device 204b.

In step 330, the system 100 may receive a damage report from the third client device 204c associated with the driver. The damage report may include photos and/or videos of the vehicle taken by the third client device 204c at various stages of the vehicle being in the possession of the driver associated with the third client device 204c. The photos and/or videos may include various images and video of the exterior and interior of the vehicle so as to give full views of the vehicle. For example, the second client device 204c may have taken photos and/or videos when the driver retrieved the vehicle and before the driver had driven the vehicle to the auto shop, photos and/or videos after arriving at the auto repair shop and before giving the auto repair shop possession of the vehicle, photos and/or videos of the vehicle after the driver retrieved possession of the vehicle from the auto shop and before the driver drives the vehicle back to the vehicle owner, photos and/or videos of the vehicle after the driver returns the vehicle to the possession of the owner, etc. The damage report may also include notes entered into the third client device 204c detailing any known damage of the vehicle that occurred while the vehicle was in the possession of the driver.

In step 332, the system 100 may process the damage report. In processing the damage report, the system 100 may compare and analyze the photos and/or videos taken at various times while the vehicle was in the possession of the driver. From the comparison and analysis, the system 100 may identify any damage that occurred while the vehicle was either in the possession of the driver or in the possession of the auto shop. The system 100 may generate a final damage report indicating whether any new damage was identified, whether any new damage occurred in the possession of the driver or in the possession of the auto shop, any notes left by the driver or the auto shop that would be relevant to any new damage, etc.

In step 334, the system 100 may provide the damage report to the first client device 204a. If new damage did not occur to the vehicle, the damage report provided to the first client device 204a may be a brief statement that no new damage was identified to the vehicle. If new damage did occur to the vehicle, the damage report provided to the first client device 204a may provide a brief explanation of the damage found and before and after photos and/or video segments highlighting the new damage.

In step 336, the system 100 may receive reviews from the first client device 204a. The reviews received may indicate the satisfaction the owner had with the auto shop that handled the repair of the vehicle. The reviews received may also indicate the satisfaction the owner had with the driver.

Alternatively, the system 100 may not request a bid, order the auto shops, or order the drivers based on availability as described above. Instead, the system 100 may generate and automatically assign a shop repair request to one second client device associated with an auto shop that is available and most convenient given the location of the vehicle and type of service requested. Additionally, the system may generate and provide to one or more third client devices associated with drivers the driver repair request together with an option to claim the driver repair request. One of the third client devices may exercise the option and claim the driver repair request. Once the driver repair request is claimed, the system may remove the option to claim from the remaining third party client devices.

In an alternative embodiment, the system 100 may not generate and provide a shop repair request. In the alternative, the system may provide a driver repair request as described above. As part of the driver repair request, the system may generate and provide a computer-readable barcode, such as a QR code, or other code known in the art. The code may contain information related to the repair request pertinent to an auto shop as described above. The system 100 may provide to a third client device associated with a driver the option to indicate that the vehicle has been delivered to an auto shop.

Additionally, the system 100 may provide to the third client device the option to select additional repairs recommended by the shop. Upon receiving a selection of additional repairs from the third client device, the system may generate an optional repair request and provide the optional repair request for display on the first client device. The system 100 may place a time limit for acceptance of the optional repair request such that if the optional repair request is not accepted by the owner client device within a set amount of time, it will expire. The system 100 may receive from the owner client device an acceptance of the optional repair request and generate a new machine-readable code containing information about the acceptance of the optional repair request to the third client device.

One skilled in the art would recognize that the steps described above may be arranged in varying orders from the order presented above. Furthermore, the steps described above may be combined into fewer steps or split up into more steps.

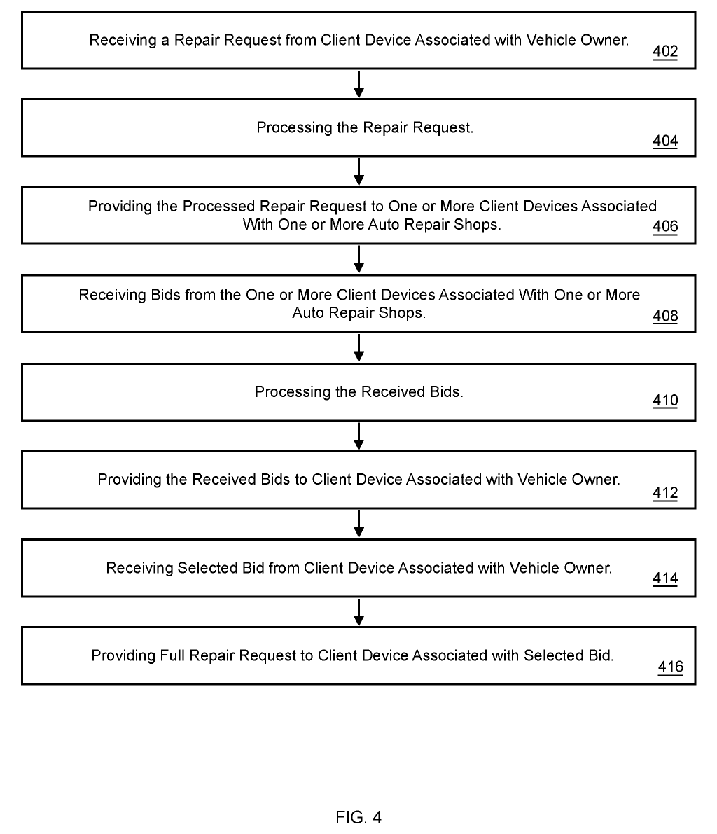

With reference now to FIG. 4, a flowchart of one exemplary method 400 of coordinating vehicle repair with one or more principles described herein is illustrated. While FIG. 4 illustrates example steps according to one embodiment, other embodiments may omit, add to, place in a different order, and/or modify any of the steps shown in FIG. 4. One or more of the steps of method 400 may be performed by any of the components described in connection with system 100 of FIG. 1. In addition, one or more steps of method 400 may be performed by one or more of the system 100 or client devices 204 associated with the system 100.

Step 402 may be included in the method 400 and may include receiving an owner repair request from a first client device associated with a vehicle owner. As described above, request manager 102 may receive the owner repair request from a vehicle owner by way of the client device 204a having a username and password associated with the vehicle owner. The repair request may contain the vehicle owner’s name, address, phone number, email address, vehicle make, vehicle model, vehicle year, vehicle engine type, vehicle VIN number, the license plate number, the type of repair requested, or any other piece of information described herein.

Method 400 may further include step 404 of processing the owner repair request. Processing the repair request may include abbreviating the repair request to only include certain information. For example, the repair request may be processed to an abbreviated repair request contain only the vehicle information including vehicle make, vehicle model, vehicle year, vehicle engine type. The abbreviated repair request may further include the type of repair requested. In the alternative, the processing may include generating a shop repair request contain information as already described herein.

Step 406 may also be included which may be providing the processed repair request to one or more client devices associated with one or more auto repair shops. The auto repair shops through the one or more client devices may view the processed repair requests and determine whether they would like to place bids on the repair request.

Method 400 may further include step 408 of receiving bids from the one or more client devices associated with the one or more auto repair shops. The received bids may include the auto shops information such as the auto shop’s address, phone number and email, estimated cost of making the repair, and estimated time to complete the repair.

Method 400 may further include step 410 of processing the received bids. As described above, the request manager 102 may process the received bids in order of most to least favorable. In processing the bids, the request manager 102 may analyze certain factors including, the estimated cost of the repair, the estimated time to make the repair, the distance from the vehicle to the auto repair shop, internal or external reviews of the auto repair shop, etc. Internal reviews may be reviews received from users of the system 100. External reviews may be reviews from third parties not associated with the system 100 or its users.

Method 400 may further include step 412 of providing the processed bids to the client device associated with the vehicle owner. Through the client device, the vehicle owner may view the processed bids from most favorable to least favorable. The vehicle owner through the client device may then select a bid to proceed with the repair of the vehicle.

Method 400 may further include step 414 of receiving the selected bid from the client device associated with the vehicle owner.

Method 400 may further include step 416 of providing a full repair request to the client device associated with the selected bid. Upon receiving the full repair request the client device associated with the selected bid may view all of the information associated with the repair request and begin to make preparations to receive the vehicle to repair.

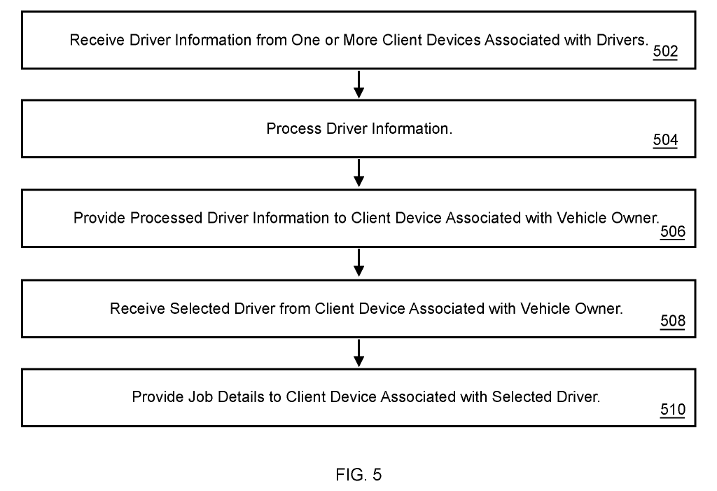

With reference now to FIG. 5, a flowchart of another exemplary method 500 of coordinating vehicle repair in accordance with one or more principles described herein is illustrated. While FIG. 5 illustrates example steps according to one embodiment, other embodiments may omit, add to, place in a different order, and/or modify any of the steps shown in FIG. 5. One or more of the steps of method 500 may be performed by any of the components described in connection with system 100 of FIG. 1. In addition, one or more steps of method 500 may be performed by one or more of the system 100 or client devices 204 associated with the system 100.

Method 500 may further include step 502 of receiving driver information from one or more client devices associated with drivers, a driver being an individual associated with the system 100 to pick up and drive owner vehicles to selected auto shops. Driver information may include driver’s name, driver’s age, driver’s current physical location, driver’s driving record, driver’s reviews, etc.

Method 500 may further include step 504 of processing the driver information received into a list of most favored driver to least favored driver. The step of processing the driver information into a list of most favored to least favored driver may include analyzing a number of factors including driver’s current physical location, driver’s driving record, deriver’s internal and external reviews, etc.

Method 500 may further include step 506 of providing the processed driver information to a client device associated with a vehicle owner. In providing the processed driver information, the vehicle owner, through the client device, may view the driver information and make a selection of a driver.

Method 500 may further include step 508 of receiving a selected driver from the client device associated with the vehicle owner.

Method 500 may further include step 510 of providing job details to the client device associated with the selected driver. The job details may include the address at which the vehicle to be repaired will be picked up, the owner’s name, the owners contact information including phone number and email address, the vehicle information including make, model and year, the address and phone number of the auto repair shop the vehicle is to be taken to, etc.

One skilled in the art will recognize that while the methods 400 and 500 above have been described as separate methods, the steps of 400 and 500 may be combined into one method of coordinating vehicle repair as can be seen in FIG. 3.

With reference now to FIG. 6, an exemplary computer device 600 is illustrated that may be configured to perform one or more of the processes described above. One skilled in the art will understand that one or more computing devices such as the computing device 600 may implement the system 100. As shown by FIG. 6, the computing device 600 may comprise a processor 602, memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 may include fewer components than those shown in FIG. 6. Components of the computing device 600 shown in FIG. 6 will now be described in additional detail.

In particular embodiments, the processor 602 may include hardware for executing instructions, such as those making up a computer program. As an example and not by way of limitation, to execute instructions, the processor 602 may retrieve the instructions from an internal register, an internal cache, the memory 604, or the storage device 606 and decode and execute them. In particular embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a Solid State Drive (“SSD”), Flash Memory, Phase Change Memory (“PCM”), or other types of data storage. The memory 604 may be internal or distributed memory.

The storage device 606 may include storage for storing data or instructions. As an example, and not by way of limitation, the storage device 606 may comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may be internal or external to the computing device 600. In particular embodiments, the storage device 606 may be non-volatile, solid-state memory. In other embodiments, the storage device 606 may include read only memory (ROM). Where appropriate, this ROM may be masked programmed ROM, programmable ROM (PROM), erasable PROM (EPROM), electrically erasable PROM (EEPROM), electrically alterable ROM (EAROM), or flash memory or a combination of two or more of these.

The I/O interface 608 may allow a user to provide input to, receive output from, and otherwise transfer data to and receive data from the computing device 600. The I/O interface 608 may include a mouse, a trackpad, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more audio speakers, and one or more audio drivers. In certain embodiments, the I/O interface 608 is configured to provide graphical data to a display for presentation to a user. The graphical data may be representative of one or more graphical user interfaces or any other graphical content as may serve a particular implementation.

The communication interface 610 may include hardware, software, or both. In any event, the communication interface 610 may provide one or more interfaces for communication (such as, for example, packet-based communication) between the computing device 600 and one or more other computing devices or networks. As an example, and not by way of limitation, the communication interface 610 may include a network interface controller (NIC) or network adapter for communication with an Ethernet or other wireless based network or a wireless NIC (WNIC) or wireless adapter for communicating with a wireless network, such as a WI-FI.

Additionally, or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a GLOBAL System for Mobile Communications (GSM) network), or other suitable wireless network or a combination thereof.

Additionally, the communication interface 610 may facilitate communications via various communication protocols. Examples of communication protocols that may be used include, but are not limited to, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”), JavaScript Object Notation (“JSON”), and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LCP) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method comprising:
receiving an owner repair request from an owner client device associated with a vehicle owner user, the repair request comprised of a plurality of content items containing information about a vehicle, one or more services requested, and repair coordination;
generating a shop repair request comprised of one or more of the content items from the owner repair request and one or more shop related content items derived from the plurality of content items of the received repair request;
providing, for display on a shop client device associated with an auto repair user, the shop repair request;
generating a driver repair request comprised of one or more of the content items from the owner repair request and one or more driver related content items;
providing, for display on one or more driver client devices associated with one or more driver users, the driver repair request and an option to claim the request;
receiving, from a claiming client device associated with a driver, a claim from the option to claim the repair request;
generating a repair ticket comprised of content items derived from the shop repair request and the driver repair request; and
providing the repair ticket for display on the owner client device.

2. The method of claim 1, further comprising, after receiving a claim from the claiming driver client device, removing, from display on one or more remaining driver client devices, the option to claim the repair request.

3. The method of claim 1, further comprising receiving, from the shop client device, status updates related to a vehicle being repaired.

4. The method of claim 3, further comprising receiving, from the claiming client device, status updates related to the vehicle being repaired.

5. The method of claim 4, further comprising generating one or more status notifications, related to the vehicle being repaired, derived from the status updates received from the shop client device and the claiming client device.

6. The method of claim 5, further comprising providing, for display on the owner client device, one or more status notifications.

7. The method of claim 1, further comprising providing, for display on the owner client device, a review interface with an option to review a shop associated with the shop client device and a driver associated with the driver client device.

8. A non-transitory computer readable storage medium including a set of instructions that, when executed by at least one processor, cause a computing device to:
receive an owner repair request from an owner client device associated with a vehicle owner user, the repair request comprised of a plurality of content items containing information about a vehicle, one or more services requested, and repair coordination;
generate a shop repair request comprised of one or more of the content items from the owner repair request and one or more shop related content items derived from the plurality of content items of the received repair request;
provide, for display on a shop client device associated with an auto repair user, the shop repair request;
generate a driver repair request comprised of one or more of the content items from the owner repair request and one or more driver related content items;
provide, for display on one or more driver client devices associated with one or more driver users, the driver repair request and an option to claim the request;
receive, from one client device associated with a driver, a claim from the option to claim the request;
generate a repair ticket comprised of content items derived from the shop repair request and the driver repair request; and
provide the repair ticket for display on the owner client device.

9. The non-transitory computer readable storage medium of claim 8, further comprising instructions that, when executed by the at least one processor, cause the system to: after receiving a claim from the claiming driver client device, remove, from display on one or more remaining driver client devices, the option to claim the repair request.

10. The non-transitory computer readable storage medium of claim 8, further comprising instructions that, when executed by the at least one processor, cause the system to: receive, from the shop client device, status updates related to a vehicle being repaired.

11. The non-transitory computer readable storage medium of claim 10, further comprising instructions that, when executed by the at least one processor, cause the system to: receive, from the claiming client device, status updates related to the vehicle being repaired.

12. The non-transitory computer readable storage medium of claim 11, further comprising instructions that, when executed by the at least one processor, cause the system to: generate one or more status notifications, related to the vehicle being repaired, derived from the status updates received from the shop client device and the claiming client device.

13. The non-transitory computer readable storage medium of claim 12, further comprising instructions that, when executed by the at least one processor, cause the system to: provide, for display on the owner client device, one or more status notifications.

14. The non-transitory computer readable storage medium of claim 8, further comprising instructions that, when executed by the at least one processor, cause the system to: provide, for display on the owner client device, a review interface with an option to review a shop associated with the shop client device and a driver associated with the driver client device.

15. A system comprising:
at least one processor; and
at least one non-transitory computer readable storage medium storing instructions that, when executed by the at least one processor, cause the system to:
receive an owner repair request from an owner client device associated with a vehicle owner user, the repair request comprised of a plurality of content items containing information about a vehicle, one or more services requested, and repair coordination;
generate a shop repair request comprised of one or more of the content items from the owner repair request and one or more shop related content items derived from the plurality of content items of the received repair request;
provide, for display on a shop client device associated with an auto repair user, the shop repair request;
generate a driver repair request comprised of one or more of the content items from the owner repair request and one or more driver related content items;
provide, for display on one or more driver client devices associated with one or more driver users, the driver repair request and an option to claim the request;
receive, from one client device associated with a driver, a claim from the option to claim the request;
generate a repair ticket comprised of content items derived from the shop repair request and the driver repair request; and
provide the repair ticket for display on the owner client device.

16. The system of claim 15, further comprising instructions that, when executed by the at least one processor, cause the system to: after receiving a claim from the claiming driver client device, remove, from display on one or more remaining driver client devices, the option to claim the repair request.

17. The system of claim 15, further comprising instructions that, when executed by the at least one processor, cause the system to: receive, from the shop client device, status updates related to a vehicle being repaired.

18. The system of claim 17, further comprising instructions that, when executed by the at least one processor, cause the system to: receive, from the claiming client device, status updates related to the vehicle being repaired.

19. The system of claim 18, further comprising instructions that, when executed by the at least one processor, cause the system to: generate one or more status notifications, related to the vehicle being repaired, derived from the status updates received from the shop client device and the claiming client device.

20. The system of claim 19, further comprising instructions that, when executed by the at least one processor, cause the system to: provide, for display on the owner client device, one or more status notifications.
